(19) United States
(12) Patent Application Publication
(10) Pub. No.: US 2011/0099882 A1
(43) Pub. Date: May 5, 2011

(54) Illuminated lures

(76) Inventor: Bruce A. Young, Titusville, FL (US)

(21) Appl. No.: 12/590,298

(22) Filed: Nov. 5, 2009

(51) Int. Cl. A01K 85/01

(52) U.S. Cl. 43/17.6

(57) ABSTRACT

An illuminated lure includes a fishing lure body, a laser source provided in the fishing lure body and adapted to emit a laser beam and a light source provided in the fishing lure body and adapted to emit a light beam.

### FIELD

The present disclosure generally relates to fishing lures. More particularly, the present disclosure relates to illuminated fishing lures having both light-emitting and laser-emitting capabilities to attract fish to the lures from a distance and enhance the striking action of the fish on the lures, respectively.

### BACKGROUND

It has been found that emitting a laser beam from a fishing lure in a water body enhances striking of fish on the lure. However, under circumstances in which fish in the water body are unable to sight the laser beam emitted from the lure, such as may occur in murky water or in water which contains dense vegetation, for example, the emitted laser beam may only be effective in attracting fish which are in close proximity to the lure. Emitting a light beam from a fishing lure may be effective in attracting fish to the lure from a distance and therefore, increase the strike zone of the lure in the water body.

Therefore, illuminated fishing lures having a light-emitting capability to attract fish to the lures from a distance and a laser-emitting capability to enhance the striking action of the fish on the lures are needed.

### SUMMARY

The present disclosure is generally directed to an illuminated lure. An illustrative embodiment of the illuminated lure includes a fishing lure body, a laser source provided in the fishing lure body and adapted to emit a laser beam and a light source provided in the fishing lure body and adapted to emit a light beam.

### BRIEF DESCRIPTION OF THE DRAWINGS

The disclosure will now be made, by way of example, with reference to the accompanying drawings, in which:

FIG. 1 is a longitudinal sectional view of an illustrative embodiment of the illuminated lures;

FIG. 1A is an enlarged sectional view of a portion of the lure body of an alternative illustrative embodiment of the illuminated lure, more particularly illustrating a laser aperture provided in the lure body and a laser beam emitted through the laser aperture;

FIG. 2 is a schematic block diagram of a lure illumination system which is suitable for implementation of an illustrative embodiment of the illuminated lures;

FIG. 3 is a longitudinal sectional view of an alternative illustrative embodiment of the illuminated lures;

FIG. 4 is a longitudinal sectional view of an illustrative embodiment of the illuminated lures configured as a jig head;

FIG. 5 is a schematic block diagram of an alternative lure illumination system which is suitable for implementation of an illustrative embodiment of the illuminated lures;

FIG. 6 is a longitudinal sectional view of an illustrative embodiment of the illuminated lures configured as a spinner bait;

FIG. 7 is a side view, partially in section, of an illustrative embodiment of the illuminated lures configured as a plastic worm;

FIG. 8 is a top view of an illustrative embodiment of the illuminated lures configured as a crab;

FIG. 9 is a longitudinal sectional view of an illustrative jointed swim bait embodiment of the illuminated lures;

FIG. 10 is a longitudinal sectional view of an illustrative embodiment of the illuminated lures, more particularly illustrating emission of a laser beam and a light beam from opposite sides of the lure;

FIG. 11 is a longitudinal sectional view of an illustrative embodiment of the illuminated lures, more particularly illustrating emission of a laser beam and a light beam from respective eyes of the lure;

FIG. 12 is a longitudinal sectional view of an illustrative embodiment of the illuminated lures, more particularly illustrating a spring-loaded battery provided in a battery cavity in the lure body and a tail cone threaded into the lure body against the battery;

FIG. 13 is a perspective view, partially in section, of an illustrative technique for replacing the battery in the lure illustrated in FIG. 12; and

FIG. 14 is a longitudinal sectional view of an illustrative embodiment of the illuminated lures, more particularly illustrating an exemplary nose cone technique for securing a battery in the lure.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

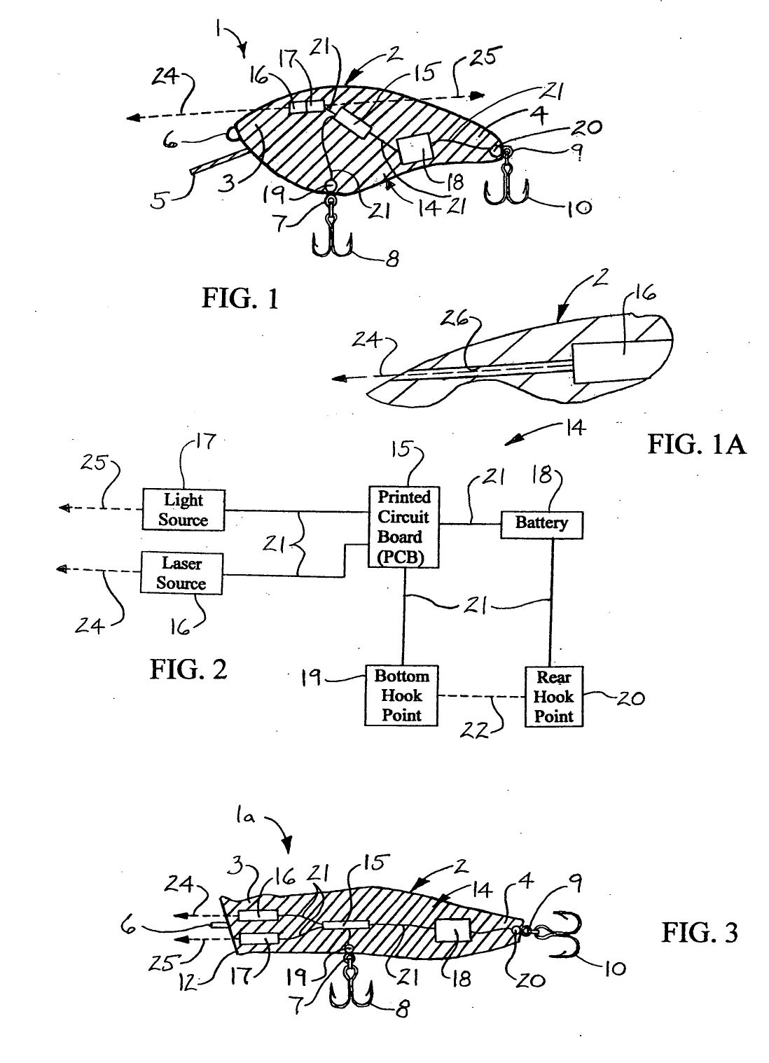

Referring initially to FIGS. 1, 1A and 2 of the drawings, an illustrative embodiment of an illuminated lure is generally indicated by reference numeral 1 in FIG. 1. The illuminated lure 1 includes a lure body 2 (illustrated in longitudinal cross-section) which in some embodiments may be a hard lure body constructed of plastic or other moldable material such as ABS plastics, balsa wood or other material molded using an injection molding or fabricated using another process. In some embodiments, the lure body 2 may be translucent. In other embodiments, the lure body 2 may be painted or otherwise fashioned to resemble the appearance and texture of any type or class of marine animal which is capable of attracting game fish as potential prey in the water body in which the illuminated lure 1 is submerged or along the surface of which the illuminated lure 1 is drawn. The lure body 2 may include a head portion 3 and a tail portion 4 generally at opposite ends of the lure body 2. A diving blade 5 may extend forwardly from the head portion 3. A fishing line hook eye 6 may be embedded in the head portion 3 of the lure body 2 to facilitate attachment of a fishing line (not illustrated) to the lure body 2 typically in the conventional manner. A bottom hook eye 7, to which is attached a bottom treble hook 8, may be embedded in the lure body 2 generally between the head portion 3 and the tail portion 4. A rear hook eye 9, to which is attached a rear treble hook 10, may be embedded in the tail portion 4 of the lure body 2.

A lure illumination system 14 is provided in the lure body 2 of the illuminated lure 1. The lure illumination system 14 may include a printed circuit board (PCB) 15. A laser source 16, adapted to emit a laser beam 24, and a light source 17, adapted to emit a light beam 25, may be electrically connected to the PCB 15. A battery 18 may be electrically connected to the PCB 15. A bottom hook contact 19 which is disposed in electrical contact with the bottom hook eye 7 (FIG. 1) may be electrically connected to the PCB 15. A rear hook contact 20 which is disposed in electrical contact with the rear hook eye 9 (FIG. 1) may be electrically connected to the battery 18. The laser source 16, the light source 17, the battery 18 and the bottom hook contact 19 may be electrically connected to the PCB 15, and the rear hook contact 20 may be electrically connected to the battery 18, via any suitable electrical connection 21 which may include wiring or direct electrical contact, for example and without limitation. In application of the illuminated lure 1, which will be hereinafter described, water (not illustrated) in a water body in which the illuminated lure 1 is submerged or along the surface of which the illuminated lure 1 is reeled provides an electrical pathway 22 (FIG. 2) between the bottom hook eye 7 and the rear hook eye 9. The electrical pathway 22 completes the circuit between the PCB 15, the battery 18, the bottom hook contact 19 and the rear hook contact 20 and the PCB 15 energizes the laser source 16 and the light source 17. Upon removal of the illuminated lure 1 from the water body, the electrical pathway 22 between the bottom hook eye 7 and the rear hook eye 9 is broken, de-energizing the laser source 16 and the light source 17.

The various components of the lure illumination system 14 may be embedded in the lure body 2. In some methods of fabrication, the components of the lure illumination system 14 may be encapsulated inside the lure body 2 either while the lure body 2 is being molded and shaped or by a mechanical process such as splitting or otherwise creating a cavity in the molded lure body 2 and placing the components of the lure illumination system 14 therein according to techniques that are well-known to those skilled in the art.

The laser source 16 of the lure illumination system 14 may be any type of device such as a laser diode, for example and without limitation, which is capable of generating the laser beam 24 via the process of stimulated emission. The light source 17 may be any type of optoelectronic device which is capable of generating the light beam 25 via the process of electroluminescence such as a light-emitting diode (LED), for example and without limitation. In some embodiments, the laser source 16 may be configured to emit the laser beam 24 in a continuous mode. In other embodiments, the laser source 16 may be configured to emit the laser beam 24 in an intermittent or blinking mode. Likewise, the light source 17 may be configured to emit the light beam 25 in a continuous mode in some embodiments and in an intermittent mode in other embodiments. The laser beam 24 and the light beam 25 may be any desired color. In some embodiments, the laser beam 24 may be blue, green, yellow, violet, ultraviolet or infrared, for example and without limitation. In some embodiments, the light beam 25 may be blue or green to enhance the distance through which the light beam 25 travels in a water body (not illustrated) in application of the illuminated lure 1 which will be hereinafter described.

The laser source 16 and the light source 17 may be placed in any desired location and orientation within the lure body 2 depending on such factors as the desired illumination effect of the laser beam 24 on the lure body 2 or on an exterior element or elements of the lure body 2 or the desired point of emission of the light beam 25 from the lure body 2 into the water body in which the illuminated lure 1 is submerged. As illustrated in FIG. 1, in some embodiments the laser source 16 may be oriented generally toward the head portion 3 whereas the light source 17 may be oriented generally away from the tail portion 4 of the lure body 2. Accordingly, the laser beam 24 is emitted from the laser source 16 generally into the head portion 3 of the lure body 2 and the light beam 25 is emitted from the light source 17 generally from the tail portion 4 of the lure body 2. However, it is to be understood that in other embodiments the laser source 16 may be suitably positioned and oriented within the lure body 2 such that the laser beam 24 is emitted generally into the tail portion 4 of the lure body 2, into the middle portion of the lure body 2 or from the head portion 3 of the lure body 2 against the diving blade 5, for example and without limitation. Similarly, the light source 17 may be suitably positioned and oriented within the lure body 2 such that the light beam 25 is emitted from the head portion 3, the middle portion of the lure body 2 or from any other point on the lure body 2. In embodiments in which the lure body 2 is non-translucent, a beam corridor (not illustrated) may extend from the discharge end of the laser source 16 to the exterior of the lure body 2 and from the discharge end of the light source 17 to the exterior of the lure body 2 to convey the laser beam 24 and the light beam 25, respectively, from the lure body 2. In other embodiments, the discharge end of the laser source 16 and the discharge end of the light source 17 may be disposed at the exterior surface of the lure body 2.

As illustrated in FIG. 1A, in some embodiments a laser aperture 26 may extend through the lure body 2 and discharge on the exterior surface of the lure body 2. The outlet of the laser source 16 may be aligned with the laser aperture 26 and the laser beam 24 may be emitted from the laser source 16 through the laser aperture 26.

In typical application of the illuminated lure 1, a fishing line (not illustrated) attached to a rod and reel (not illustrated) is tied to the fishing line hook eye 6 on the lure body 2. Upon casting of the illuminated lure 1 into a water body (not illustrated), the lure body 2 is submerged in the water body. In other embodiments, the illuminated lure 1 may be drawn along the surface of the water body by operation of the rod and reel. Accordingly, water in the water body forms the electrical pathway 22 (FIG. 2) between the bottom hook eye 7 and the rear hook eye 9. Thus, the circuit between the PCB 15, the battery 18, the bottom hook contact 19 and the rear hook contact 20 is completed and the PCB 15 energizes the laser source 16 and the light source 17 via the battery 18.

As the illuminated lure 1 is typically drawn through the water body or along the surface of the water body by actuation of the rod and reel, the laser source 16 emits the laser beam 24 into or from the lure body 2. Simultaneously, the light source 17 emits the light beam 25 from the lure body 2 into the water body. The light beam 25 may penetrate the water body at a distance of typically several feet or several yards from the illuminated lure 1, depending on such factors as the murkiness of the water body and the density of vegetation growing in the water body. Consequently, game fish swimming in the water body at a distance from the illuminated lure 1 within the distance of penetration of the light beam 25 into the water body may sight the light beam 25 and the illuminated lure 1. The laser beam 24 illuminates the lure body 2 and/or an external feature such as the diving blade 5 of the illuminated lure 1, inducing the game fish to strike the illuminated lure 1. The light beam 25 may be reflected outwardly in the water body to enlarge the strike zone of the fish swimming in the area of the illuminated lure 1.

When a game fish sets the bottom treble hook 8 and the rear treble hook 10 on the illuminated lure 1, the rod and reel is operated to reel the fishing line to which the illuminated lure 1 is attached from the water body. It will be appreciated by those skilled in the art that the electrical pathway 22 between the bottom hook eye 7 and the rear hook eye 9 is broken as the illuminated lure 1 exits the water body, de-energizing the laser source 16 and the light source 17. This feature ensures that the laser source 16 and the light source 17 are energized only when the illuminated lure 1 is submerged in the water body and conserves the electrical power stored in the battery 18 when the illuminated lure 1 is not in use.

Referring next to FIG. 3 of the drawings, an alternative illustrative embodiment of the illuminated lure is generally indicated by reference numeral 1a. The lure body 2 (illustrated in longitudinal cross-section) of the illuminated lure 1a may be shaped in the form of a jerk bait. A mouth 12 may be provided on the head portion 3 of the lure body 2. In some embodiments, the laser source 16 and the light source 17 may be positioned and oriented in the lure body 2 in such a manner that the laser beam 24 is emitted from the laser source 16 and the light beam 25 is emitted from the light source 17 through the mouth 12 of the illuminated lure 1a. In other embodiments, the laser source 16 and the light source 17 may be positioned and oriented such that the laser beam 24 and the light beam 25 are emitted from other points or locations inside or on the surface of the lure body 2.

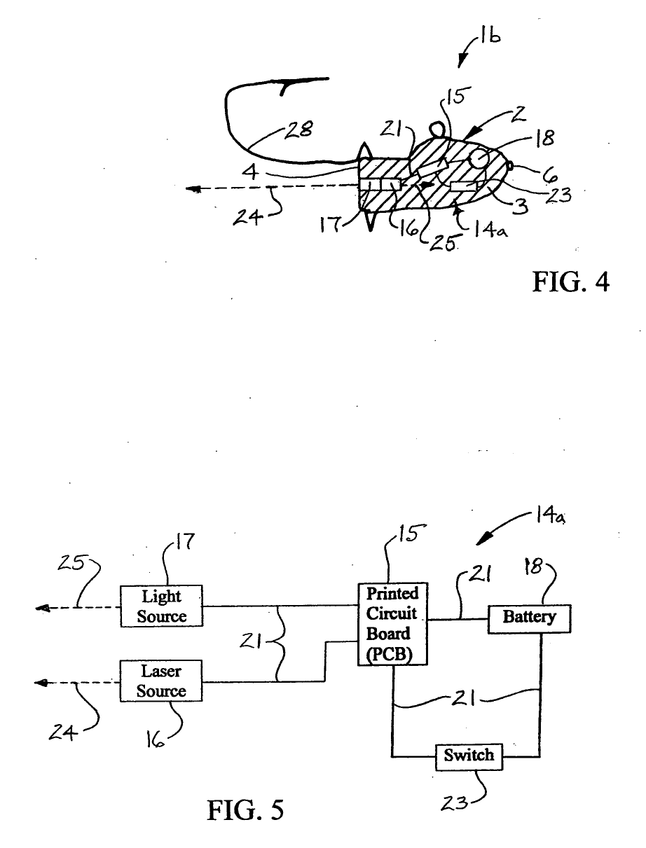

Referring next to FIGS. 4 and 5 of the drawings, another alternative illustrative embodiment of the illuminated lure is generally indicated by reference numeral 1b in FIG. 4. The lure body 2 (illustrated in cross-section) of the illuminated lure 1b may be shaped in the form of a jig head. A hook 28 may extend rearwardly from the tail portion 4 of the lure body 2.

A lure illumination system 14a is provided in the lure body 2. As illustrated in FIG. 5, in the lure illumination system 14a, a switch 23 may be electrically connected between the PCB 15 and the battery 18. The switch 23 may be a water pressure switch, a motion-activated switch, a manual switch or any other type of switch which is suitable for the purpose of closing an electrical circuit between the battery 18 and the PCB 15 to energize the laser source 16 and the light source 17 and opening the circuit to de-energize the laser source 16 and the light source 17. As illustrated in FIG. 4, in some embodiments the laser source 16 may be positioned and oriented such that the laser beam 24 which is emitted therefrom illuminates the middle portion and the head portion 3 of the lure body 2. The light source 17 may be oriented such that the light beam 25 emitted therefrom exits the tail portion 4 of the lure body 2. In other embodiments, the laser source 16 and the light source 17 may be positioned and oriented such that the laser beam 24 and the light beam 25 are emitted from other points or locations inside or on the surface of the lure body 2.

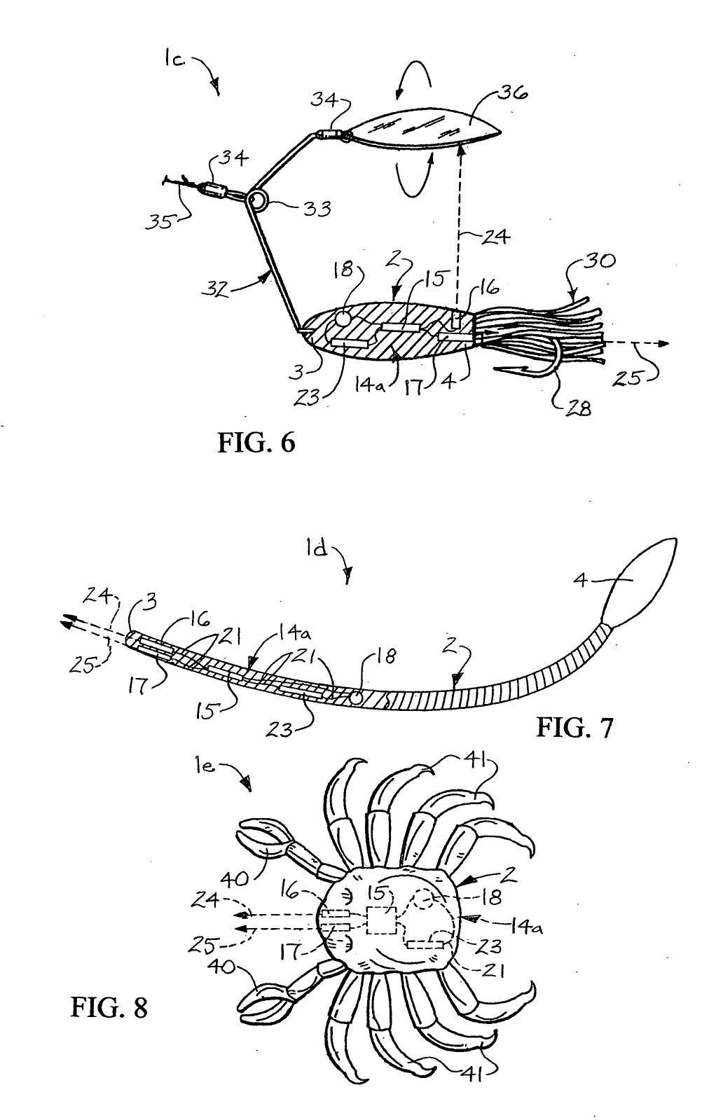

Referring next to FIG. 6 of the drawings, an illustrative spinner bait embodiment of the illuminated lure is generally indicated by reference numeral 1c. Accordingly, a wire harness 32 may extend from the head portion 3 of the lure body 2 (illustrated in cross-section). A harness eye 33 may be shaped in the wire harness 32. A swivel 34, to which is attached a fishing line 35, may be attached to the harness eye 33. A rotating spinner blade 36 may be attached to the extending or distal end of the wire harness 32 via a swivel 34. An undulating skirt 30 may extend from the tail portion 4 of the lure body 2. A hook 28 may extend from the tail portion 4 of the lure body 2 through the skirt 30.

A lure illumination system 14a (FIG. 5) may be provided in the lure body 2 of the illuminated lure 1c. In some embodiments, the laser source 16 may be oriented in the lure body 2 in such a manner that the emitted laser beam 24 exits the lure body 2 and strikes and is reflected from the rotating spinner blade 36 as the illuminated lure 1c is drawn through the water body. The light source 17 may be oriented in the lure body 2 in such a manner that the emitted light beam 25 exits the tail portion 4 of the lure body 2 and illuminates the skirt 30. In other embodiments, the laser source 16 and the light source 17 may be positioned and oriented such that the laser beam 24 and the light beam 25 are emitted from other points or locations inside or on the surface of the lure body 2.

Referring next to FIG. 7 of the drawings, an illustrative worm bait embodiment of the illuminated lure is generally indicated by reference numeral 1d. The lure body 2 of the illuminated lure 1d may be a soft plastic which is used in the fabrication of soft plastic lures according to the knowledge of those skilled in the art. A lure illumination system 14a may be provided in the lure body 2 of the illuminated lure 1d. In some embodiments, the laser source 16 and the light source 17 may be oriented in the lure body 2 in such a manner that the emitted laser beam 24 and the light beam 25, respectively, exit the head portion 3 of the lure body 2, as illustrated. In other embodiments, the laser source 16 and/or the light source 17 may be positioned and oriented such that the laser beam 24 and/or the light beam 25 is/are emitted from the tail portion 4 or other points or locations inside or on the surface of the lure body 2.

Referring next to FIG. 8 of the drawings, an illustrative crab bait embodiment of the illuminated lure is generally indicated by reference numeral 1e. The illuminated lure 1e may include a lure body 2 from which extends a pair of claws 40 and multiple pairs of legs 41 to generally approximate the appearance of a crab. In some embodiments, the lure body 2, the claws 40 and the legs 41 of the illuminated lure 1e may be a soft plastic which is used in the fabrication of soft plastic lures according to the knowledge of those skilled in the art. A lure illumination system 14a may be provided in the lure body 2 of the illuminated lure 1e. In some embodiments, the laser source 16 and the light source 17 may be oriented in the lure body 2 in such a manner that the emitted laser beam 24 and the light beam 25, respectively, exit the front of the lure body 2, as illustrated. In other embodiments, the laser source 16 and/or the light source 17 may be positioned and oriented such that the laser beam 24 and/or the light beam 25 is/are emitted from other points or locations inside or on the surface of the lure body 2. In some embodiments, the illuminated lure 1 may be fabricated to resemble the appearance of a crawfish or other crustacean.

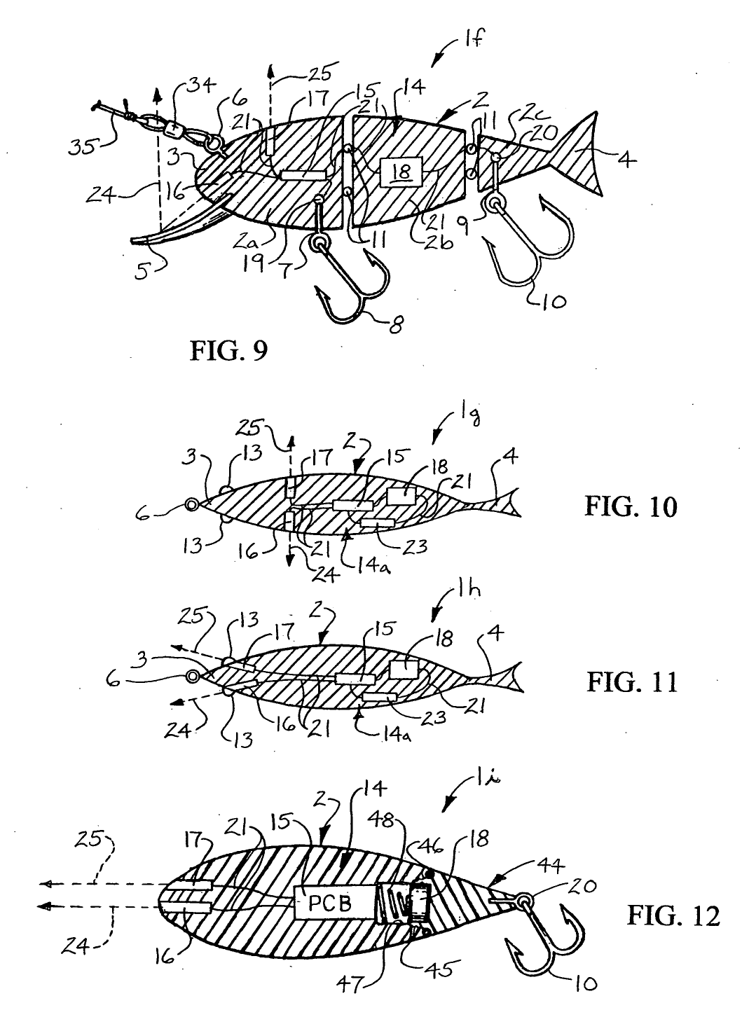

Referring next to FIG. 9 of the drawings, an illustrative jointed swim bait embodiment of the illuminated lure is generally indicated by reference numeral 1f. The lure body 2 of the illuminated lure 1f may include a front body segment 2a and a rear body segment 2c which are pivotally attached to a middle body segment 2b via respective sets of segment hinges 11. A bottom hook eye 7 may be embedded in the front body segment 2a of the lure body 2. A rear hook eye 9 may be embedded in the rear body segment 2c of the lure body 2. A diving blade 5 may extend forwardly from the front body segment 2a. A fishing line hook eye 6, to which is attached a fishing line 35 via a swivel 34, may be embedded in the head portion 3 at the front body segment 2a of the lure body 2.

A lure illumination system 14 (FIG. 2) may be provided in the lure body 2 of the illuminated lure 1f. In some embodiments, the various components of the lure illumination system 14 in the front body segment 2a, the middle body segment 2b and the rear body segment 2c of the lure body 2 may be connected to each other through the electrical connections 21 and the segment hinges 11. For example, as illustrated in FIG. 9, in some embodiments the PCB 15, the laser source 16, the light source 17 and the bottom hook contact 19 may be provided in the front body segment 2a; the battery 18 may be provided in the middle body segment 2b; and the rear hook contact 20 may be provided in the rear body segment 2c of the lure body 2. The electrical connection 21 which connects the battery 18 to the PCB 15 may be routed through one of the segment hinges 11 which connect the middle body segment 2b to the front body segment 2a. The electrical connection 21 which connects the rear hook contact 20 to the battery 18 may be routed through one of the segment hinges 11 which connect the rear body segment 2c to the middle body segment 2b. In other embodiments, the electrical connections 21 may bypass the segment hinges 11 and extend between the middle body segment 2b and the front body segment 2a and between the rear body segment 2c and the middle body segment 2b of the lure body 2.

As further illustrated in FIG. 9, in some embodiments the laser source 16 may be positioned and oriented in the lure body 2 such that the laser beam 24 is emitted from the laser source 16 and strikes and is reflected from the diving blade 5. The light source 17 may be positioned and oriented in the lure body 2 such that the light beam 25 is emitted from the side, top or bottom of the lure body 2. In other embodiments, the laser source 16 and/or the light source 17 may be positioned and oriented such that the laser beam 24 and/or the light beam 25 is/are emitted from other points or locations inside or on the surface of the lure body 2.

Referring next to FIGS. 10 and 11 of the drawings, another alternative illustrative embodiment of the illuminated lure is generally indicated by reference numeral 1g in FIG. 10. In the illuminated lure 1g, the laser source 16 and the light source 17 are oriented such that the laser beam 24 and the light beam 25 are emitted from opposite sides of the lure body 2. As illustrated FIG. 11, in an alternative illustrative embodiment of the illuminated lure 1h, the laser source 16 and the light source 17 are oriented such that the laser beam 24 and the light beam 25 are emitted from respective eyes 13 provided on the head portion 3 of the lure body 2.

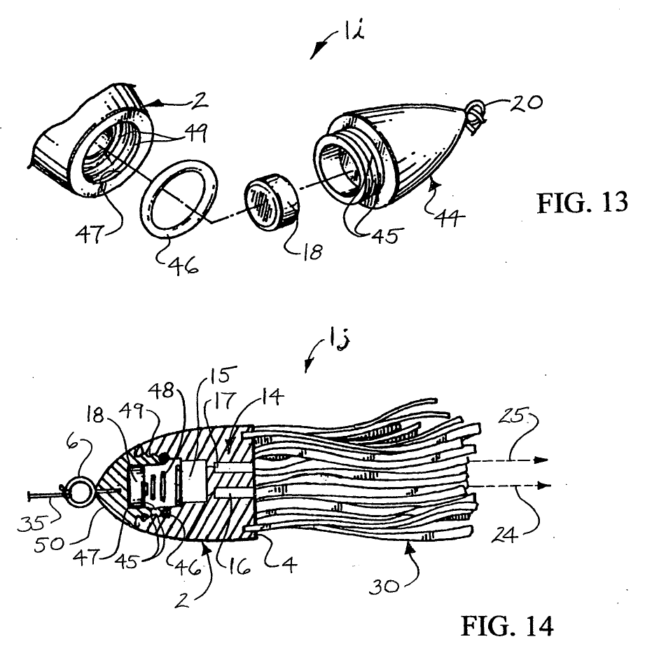

Referring next to FIGS. 12 and 13 of the drawings, another alternative illustrative embodiment of the illuminated lure is generally indicated by reference numeral 11. A battery cavity 47 may be provided in the lure body 2. The battery 18 of the lure illumination system 14 may be provided in the battery cavity 47. A removable tail cone 44 may detachably engage the lure body 2 to close the battery cavity 47 such as by engagement of cone threads 45 provided on the tail cone 44 with cavity threads 49 (FIG. 13) provided in the battery cavity 47. A gasket 46 may be interposed between the tail cone 44 and the lure body 2 for sealing purposes. The PCB 15 (FIG. 12) of the lure illumination system 14 may be disposed generally adjacent to the battery cavity 47. A spring 48 may be provided in the battery cavity 47 to establish electrical communication between the battery 18 and the PCB 15. The spring 48 may bias the battery 18 against the interior surface of the tail cone 44 in the battery cavity 47. In some embodiments, the PCB 15 may energize the laser source 16 and the light source 17 via the battery 18 upon attachment of the tail cone 44 to the lure body 2. As illustrated in FIG. 13, the battery 18 may be selectively replaced in the battery cavity 47, as needed, by unthreading the cone threads 45 on the tail cone 44 from the cavity threads 49 in the battery cavity 47 and removing the tail cone 44 from the lure body 2; removing the battery 18 from the battery cavity 47; placing a replacement battery 18 in the battery cavity 47; and replacing the tail cone 44 on the lure body 2, respectively.

Referring next to FIG. 14 of the drawings, in yet another illustrative embodiment of the illuminated lure 1j, a nose cone 50 detachably engages the lure body 2 to secure the spring 48 and the battery 18 in the battery cavity 47 in the same manner as was heretofore described with respect to the tail cone 44 in FIGS. 12 and 13. In some embodiments, the PCB 15 may energize the laser source 16 and the light source 17 via the battery 18 upon attachment of the nose cone 50 to the lure body 2. In some embodiments, an undulating skirt 30 may extend from the tail portion 4 of the lure body 2. The laser source 16 and the light source 17 may be oriented in such a manner as to emit the laser beam 24 and the light beam 25, respectively, from the tail portion 4 through the skirt 30 or may be oriented in any alternative orientations in the lure body 2 depending on the desired illumination effects which are to be imparted to the lure body 2.

It will be appreciated by those skilled in the art that the particular embodiments of the illuminated lures which were described herein above with respect to the drawings are exemplary and that the lures may include a variety of characteristics and features other than or in addition to those of the described embodiments. The illuminated lures of the present disclosure can be constructed in a wide variety of configurations of many different materials and may include lure bodies 2 which are flexible, soft or hard, as desired. The principles of the disclosure are applicable to a variety of types of hard bait, soft bait, wired bait (which include a wire for the attachment of spinner blades, buzz blades or chatter bait blades) and trolling fishing lures. Hard bait fishing lures (which may be fabricated from plastic, balsa wood and/or other material) to which the disclosure is applicable include but are not limited to crank baits, jerk baits, top water baits, lipless crank baits, shads, swim baits, jointed swim baits, frogs, rats or other baits formed of a hard plastic or other material. Soft bait fishing lures for fresh or salt water application to which the disclosure is applicable include but are not limited to swim baits, shads, worms, tube worms, grub worms, crawfish, frogs, rats or other creatures. Wired bait fishing lures for fresh and saltwater application to which the disclosure is applicable include spinner baits (single and multiple blades), buzz baits (single and multiple blades), chatter baits, inline spinners and spoons. Trolling lures for fresh and saltwater application to which the disclosure is applicable include but are not limited to deep water jigging lures, deep water soft plastic lures, deep water trolling lures and top water trolling lures.

In the various embodiments, the laser source 16 and/or the light source 17 encapsulated or enclosed in the respective lure bodies 2 may be positioned and oriented in the lure body 2 in such a manner as to illuminate or highlight the lure body 2 and/or one or more internal or external features of the laser-illuminated lures, as was described herein above. Moreover, the lure bodies 2 may be provided with the bottom hook eye 7 (FIG. 1) and the rear hook eye 9 for the attachment of treble hooks to the lure body 2 and to close the electrical circuit between the battery 18 and the PCB 15, the laser source 16 and the light source 17 of the lure illumination system 14 when the illuminated lure 1 is submerged or placed in a water body. Alternatively, the lure bodies 2 may be provided with the switch 23 to close the circuit between the battery 18 and the PCB 15 of the lure illumination system 14a.

It will be further appreciated by those skilled in the art that the laser source 16 and the light source 17 may be of any desired design which is compatible with placement inside a fishing lure in the manner which was described herein above. Accordingly, the laser source 16 may be a solid-state laser, a gas laser, a semiconductor laser or a liquid laser, as desired, depending on the capacity for miniaturizing these devices. The laser beam 24 which is emitted from the laser source 16 may be highly directional and therefore, easily focused on any desired interior or exterior element of the laser-illuminated lure. Because it may be reflected in a wider path and travel substantially further through water than the laser beam 24, the light beam 25 which is emitted from the light source 17 may be effective in attracting fish which are located at a distance from the illuminated lure while the illuminated lure is submerged in the water body. Therefore, the light beam 25 may enlarge the strike range of fish around the illuminated lure in the water body beyond that which could be achieved using the laser source 16 alone.

While various illustrative embodiments have been described above, it will be recognized and understood that various modifications can be made and the appended claims are intended to cover all such modifications which may fall within the spirit and scope of the disclosure.

What is claimed is:

1. An illuminated lure, comprising:
a fishing lure body;
a laser source provided in said fishing lure body and adapted to emit a laser beam; and
a light source provided in said fishing lure body and adapted to emit a light beam.

2. The illuminated lure of claim 1 further comprising an external feature carried by said fishing lure body and wherein at least one of said laser source and said light source is oriented to emit at least one of said laser beam and said light beam, respectively, against said external feature.

3. The illuminated lure of claim 2 wherein said external feature comprises a diving blade.

4. The illuminated lure of claim 2 wherein said external feature comprises a spinner blade.

5. The illuminated lure of claim 2 wherein said external feature comprises a skirt.

6. The illuminated lure of claim 1 further comprising a printed circuit board connected to said laser source and said light source, a battery connected to said printed circuit board, a first hook disposed in electrical contact with said printed circuit board and a second hook disposed in electrical contact with said battery.

7. The illuminated lure of claim 1 further comprising a printed circuit board connected to said laser source and said light source, a battery connected to said printed circuit board and a switch connected to said printed circuit board and said battery.

8. The illuminated lure of claim 7 wherein said switch is a water pressure switch, a motion-activated switch or a manual switch.

9. The illuminated lure of claim 1 wherein said laser source and said light source are oriented to emit said laser beam and said light beam from respective sides of said lure body.

10. The illuminated lure of claim 1 further comprising a pair of eyes provided on said lure body and wherein said laser source and said light source are oriented to emit said laser beam and said light beam from said pair of eyes, respectively.

11. The illuminated lure of claim 1 wherein said fishing lure body comprises a head portion and a tail portion and at least one of said laser source and said light source is provided in said head portion.

12. The illuminated lure of claim 1 wherein said fishing lure body comprises a head portion and a tail portion and at least one of said laser source and said light source is provided in said tail portion.

13. An illuminated lure, comprising:
a fishing lure body;
a laser illumination system provided in said fishing lure body and comprising:
a laser source provided in said fishing lure body and adapted to emit a laser beam;
a light source provided in said fishing lure body and adapted to emit a light beam;
a printed circuit board connected to said laser source and said light source;
a battery connected to said printed circuit board;
a first hook contact connected to said printed circuit board;
a first hook eye embedded in said lure body and disposed in electrical contact with said first hook contact;
a first hook carried by said first hook eye;
a second hook contact connected to said battery;
a second hook eye embedded in said lure body and disposed in electrical contact with said second hook contact; and
a second hook carried by said second hook eye.

14. The illuminated lure of claim 13 further comprising a mouth provided on said lure body and wherein at least one of said laser source and said light source is adapted to emit at least one of said laser beam and said light beam, respectively, from said mouth.

15. The illuminated lure of claim 13 wherein said lure body comprises a plurality of pivoting body segments.

16. The illuminated lure of claim 13 further comprising a battery cavity provided in said lure body, a cone detachably engaging said lure body at said battery cavity and a spring provided in said battery cavity and engaging said printed circuit board and said battery.

17. An illuminated lure, comprising:
a fishing lure body;
a laser illumination system provided in said fishing lure body and comprising:
a laser source provided in said fishing lure body and adapted to emit a laser beam via stimulated emission;
a light source provided in said fishing lure body and adapted to emit a light beam via electroluminescence;
a printed circuit board connected to said laser source and said light source;
a battery connected to said printed circuit board; and
a switch connected to said printed circuit board and said battery.

18. The illuminated lure of claim 17 wherein said light source comprises an LED.

19. The illuminated lure of claim 17 wherein said lure body comprises a plastic worm.

20. The illuminated lure of claim 17 wherein said switch is a water pressure switch, a motion-activated switch or a manual switch.
